(19) United States
(12) Patent Application Publication
(10) Pub. No.: US 2014/0024252 A1
(43) Pub. Date: Jan. 23, 2014

(54) Device to Prevent Tampering With Cable Taps

(71) Applicant: Tap Safe Technologies, LLC, DeGraff, OH (US)

(72) Inventor: Robert A. Hickman, Magnolia, TX (US)

(73) Assignee: TAP SAFE TECHNOLOGIES, LLC, DeGraff, OH (US)

(21) Appl. No.: 13/948,320

(22) Filed: Jul. 23, 2013

Related U.S. Application Data
(60) Provisional application No. 61/674,526, filed on Jul. 23, 2012.
(60) Provisional application No. 61/783,204, filed on Mar. 14, 2013.

(51) Int. Cl. H01R 13/46; E05C 19/06

(52) U.S. Cl. CPC H01R 13/46; E05C 19/06
USPC 439/527; 292/256

(57) ABSTRACT

A device for preventing tampering with a cable tap as well as a snap strip for securing the device is disclosed herein. An upper housing and lower housing may be joined to surround a cable tap and its cable feeder lines. The upper housing and lower housing may contain apertures for accepting the prongs of a snap strip for holding the device in a closed position. Apertures may be placed in the upper and lower housings for the hanger of the cable tap as well as the household cable line to exit the housings.

### CROSS-REFERENCE TO RELATED APPLICATIONS

This application claims priority to co-pending U.S. Application No. 61/674,526 filed on Jul. 23, 2012. This application also claims priority to co-pending U.S. Application No. 61/783,204 filed on Mar. 14, 2013. Both applications are herein incorporated by reference in their entirety as through fully rewritten herein.

### TECHNICAL FIELD

Embodiments generally relate to a device to prevent tampering with cable taps.

### BACKGROUND OF THE ART

Cable taps are commonly used to allow a household (or multiple households) access to the cable and/or internet signal being supplied by the feeder cable lines which are ran throughout communities. A cable tap is typically positioned in-line with the feeder cable line and may contain at least one port. Common taps that are used may contain 2, 4, 6, or 8 ports and a port can provide both internet and cable access or simply internet access. In order to connect a household for cable/internet service, the coax cable for that particular household is connected to one of the ports on the tap. The connection is typically done by a service technician, after the user agrees to payments with the cable/internet provider.

Cable theft occurs when people connect their household to the tap without contacting the cable/internet provider and without any agreement with or payments to the cable/internet provider. It is estimated that cable/internet providers lose billions of dollars in revenue each year due to cable theft. While cable theft is illegal, and carries stiff penalties (including criminal prosecution), it remains a widespread problem.

### SUMMARY OF THE EXEMPLARY EMBODIMENTS

Exemplary embodiments provide a device with upper and lower housings which can be used to surround the tap. The two housings may be secured with one another to prevent tampering with the cable tap. In one embodiment, the upper and lower housings each contain an aperture for accepting the prong of a snap strip.

The foregoing and other features and advantages of the present invention will be apparent from the following more detailed description of the particular embodiments, as illustrated in the accompanying drawings.

### BRIEF DESCRIPTION OF THE DRAWINGS

A better understanding of an exemplary embodiment will be obtained from a reading of the following detailed description and the accompanying drawings wherein identical reference characters refer to identical parts and in which:

FIG. 1 is a top perspective view of an exemplary embodiment of the tamper-resistant device containing an 8-port tap and indicating the section line 5-5.

FIG. 2 is a bottom perspective view of an exemplary embodiment of the tamper-resistant device containing an 8-port tap.

FIG. 3 is a top perspective view of an exemplary embodiment of the tamper-resistant device where the upper housing has been removed.

FIG. 4 is a top perspective view of an exemplary embodiment of the tamper-resistant device where the lower housing has been removed.

FIG. 5 is a top perspective section view of the embodiment shown in FIG. 1 and taken along the section line 5-5.

FIG. 6 is a bottom perspective view of one embodiment of the snap strip.

FIG. 7 is a detail section view taken from detail 7 shown in FIG. 5.

FIG. 8A is a top perspective view where the upper and lower housings have been shown transparent to illustrate the optional tether while the housings are in a closed position.

FIG. 8B is a top perspective view showing use of the optional tether while the housings are in an open position.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

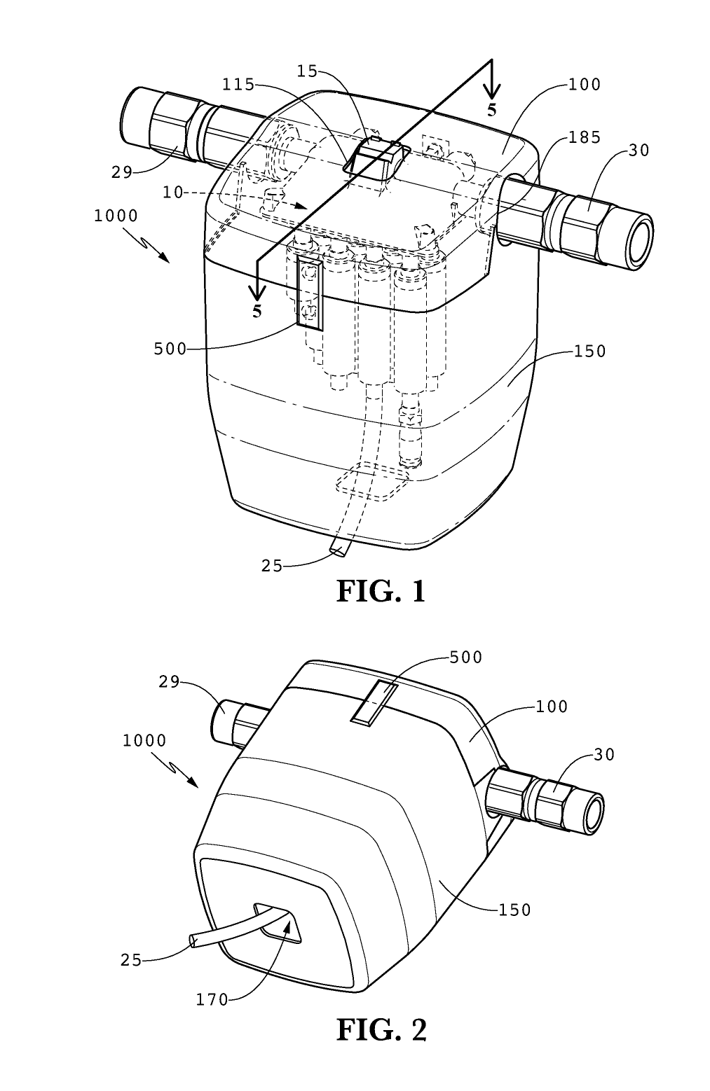

FIG. 1 is a top perspective view of an exemplary embodiment of the tamper-resistant device 1000 containing an 8-port tap 10 and indicating the section line 5-5. In this embodiment, an upper housing 100 and lower housing 150 are joined together to surround a telecommunications tap, otherwise known as a cable tap 10. Here, the upper and lower housings have been shown transparent to illustrate the position of the tap 10 within the device 1000. An aperture 115 is positioned within the upper housing 100 to allow the hanger 15 of the tap 10 to be accessible once the tap 10 has been secured within the device 1000. A snap strip 500 is preferably used to fasten the upper housing 100 and lower housing 150 together. In some embodiments, a hinge may be used so that the upper and lower housings are hingedly fastened along one edge with a snap strip 500 used on the opposing edge. In other embodiments, two or more snap strips 500 may be used to secure the device in a closed position. Here, the upper housing 100 may contain apertures 185 sized to accept the feeder cable lines 29/30 for the tap 10. Section line 5-5 is shown cutting vertically through the device 1000 and passing through the hanger 15 of the tap 10.

FIG. 2 is a bottom perspective view of an exemplary embodiment of the tamper-resistant device 1000 containing an 8-port tap 10. A bottom aperture 170 is preferably positioned on the lower housing 150 to allow a household cable line 25 to exit the device 1000.

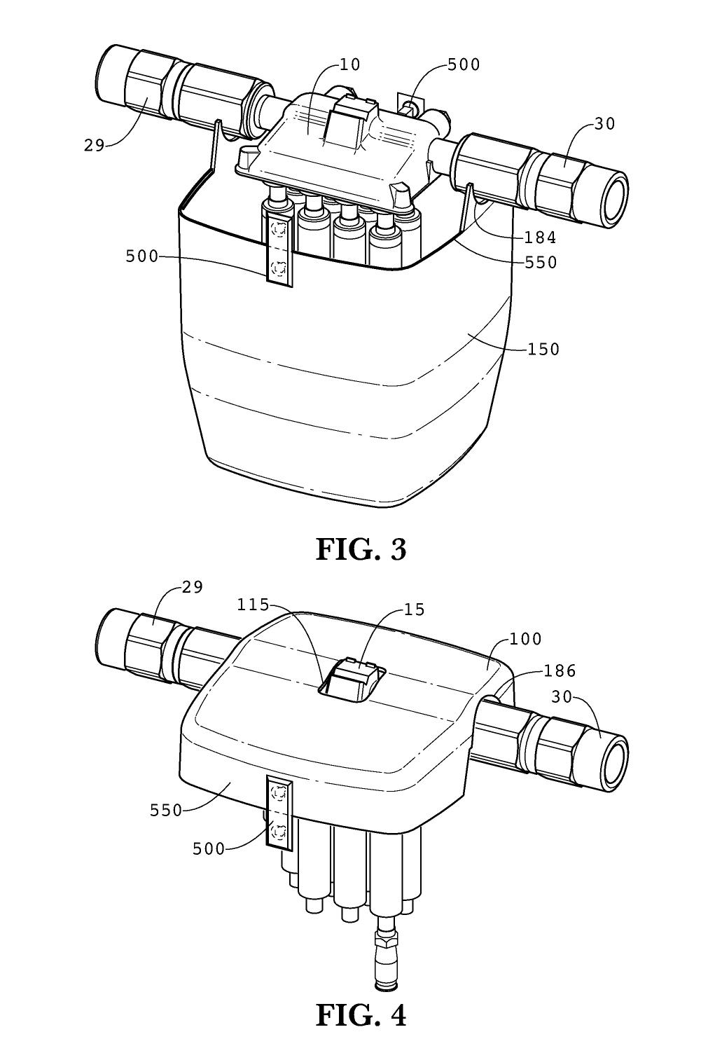

FIG. 3 is a top perspective view of an exemplary embodiment of the tamper-resistant device where the upper housing 100 has been removed. FIG. 4 is a top perspective view of an exemplary embodiment of the tamper-resistant device where the lower housing 150 has been removed. Here, the interfacing edge 550 of the upper and lower housings can be observed, which is the edge along which the two portions of the housings meet. The snap strip 500 preferably spans across this interfacing edge 550 in order to secure the device in a closed position. Also shown in this figure, is the upper portion 186 and lower portion 184 of the aperture 185 for accepting the cable feeder lines 29/30. In this embodiment, the upper portion 186 of the aperture is formed by the upper housing 100, while the lower portion 184 is formed by the lower housing 150, such that when the two housings are secured together, the cable feeder lines 29/30 are sandwiched between the upper and lower portions 186/184 of the housing.

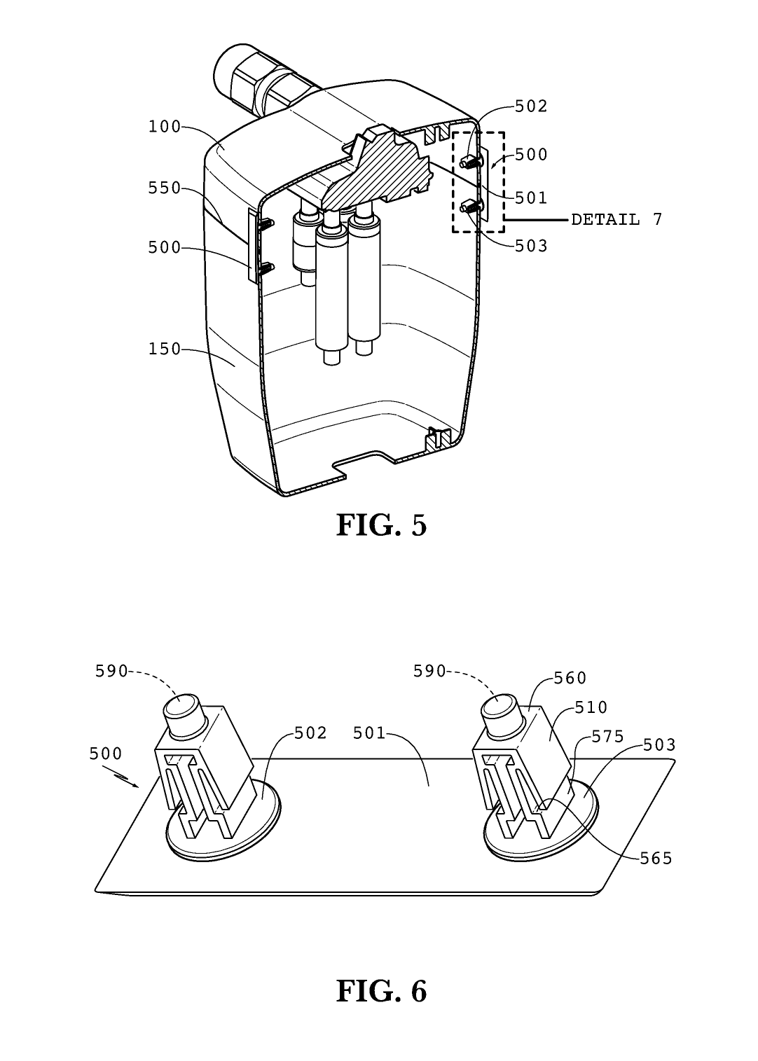

FIG. 5 is a top perspective section view of the embodiment shown in FIG. 1 and taken along the section line 5-5. In this embodiment, a pair of snap strips 500 are positioned on opposing sides of the device, each one spanning across the interfacing edge 550. In this embodiment, the snap strip 500 contains an elongate strip 501 having two ends, with a prong 502/503 positioned near each end. The prongs 502/503 are sized to initially fit through openings 101/151 in the upper and lower housings 100/150 but cannot be easily removed once they have been inserted.

FIG. 6 is a bottom perspective view of one embodiment of the snap strip 500. As noted above, an elongate strip 501 may have a first prong 502 and a second prong 503, each prong having a central axis 590. Each prong preferably contains at least one tab 510 which is attached at the top portion 560 of the prong and extends away from the central axis 590 as you move towards the base 580 of the prong of the prong. A notch 565 is preferably positioned near the base 575 so that as the prong is inserted into the housing the tab 510 can flex inwardly (towards the central axis 590) and be accepted into the notch 565.

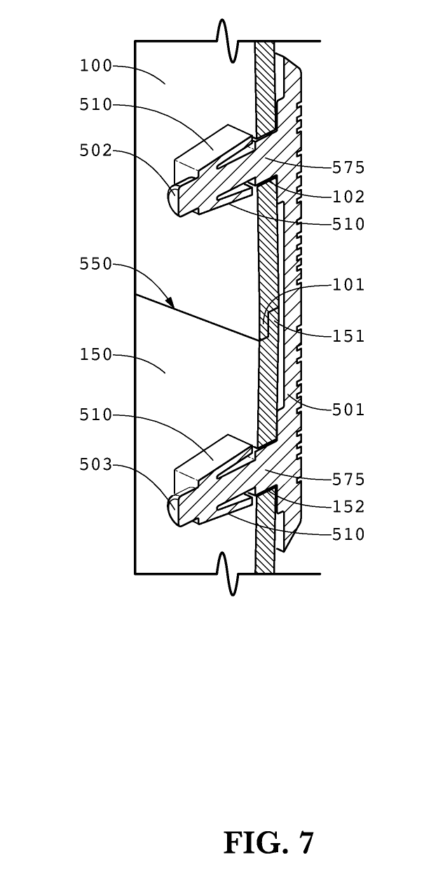

FIG. 7 is a detail section view taken from detail 7 shown in FIG. 5. In this exemplary embodiment, the upper housing 100 contains an aperture 102 for accepting the prong 502 and the lower housing 150 contains an aperture 152 for accepting the prong 503. As noted above, as each prong is inserted into its aperture the tab 510 on the prong may flex inwardly so as to pass through the aperture in the housing. Once fully inserted, a portion of the base 575 of each prong should preferably fit within the aperture 102/152 in the housing and the tab 510 should extend outwardly to prevent the prong from being removed from the housing. It should be noted that although two tabs 510 are shown for each prong this is not required, as only one tab could be used with each prong or more than one tab with each prong.

Also shown in this figure is the interfacing edge 550 of the upper and lower housings 100/150. In this embodiment, the upper housing 100 contains a ledge 101 which corresponds to a ledge 151 within the lower housing 150. The two ledges are substantial mirror images of one another so that they align the two housings in order to close the device.

The snap strip 500 can be comprised of any number of materials including plastics, composites, and metals. In an exemplary embodiment, the snap strip 500 would be comprised of injection molded plastic. Preferably, when someone desires to open the device, they must cut or sever the elongate strip 510. It is preferred that the elongate strip 510 is designed so that it could be difficult to cut or sever using typical household tools such as scissors or knives. If the owner of the device were to observe an elongate strip 510 that had been severed, then this provides a clear visual indicator of tampering which is visible from a distance (i.e. when located at the top of a service pole and viewed from the ground).

The upper 100 and lower 150 housings of the device 1000 can be comprised of any number of materials, including but not limited to plastics, composites, and metals. In an exemplary embodiment, the upper and lower housings may be injection molded plastics either with or without additives. Although shown in the figures with an 8-port tap, it will be recognized by one of skill in the art that the embodiments shown and described in this application can be used with any type of tap used in the cable, internet, or general telecommunications industry.

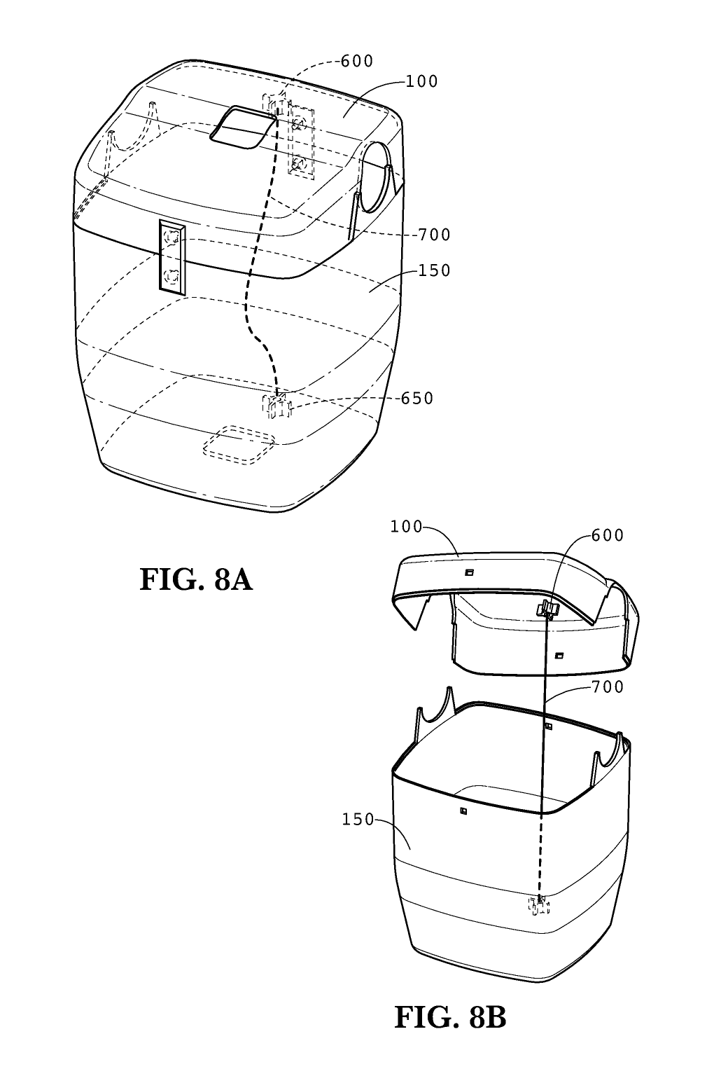

FIG. 8A is a top perspective view where the upper 100 and lower 150 housings have been shown transparent to illustrate the optional tether 700 while the housings are in a closed position. In this embodiment, the upper housing 100 contains an upper tether attachment point 600 while the lower housing 150 contains a lower tether attachment point 650. The tether can be any flexible elongate member, including but not limited to a cable, string, rope, wire, strip, or band. The attachment points 600 and 650 can include any one of the following: a boss with a screw, a hook, a loop, a post with a hole, a snap fastener, or any means for securing the tether 700 to the upper/lower housings.

FIG. 8B is a top perspective view showing use of the optional tether 700 while the housings are in an open position. Here, the lower housing 150 is permitted to hang from the upper housing 100 via the tether 700. In this way, a user can gain access to the interior of the housing (for installing, servicing, or replacing the tap) without having to fully remove the lower housing 150 or risk dropping or losing the lower housing 150.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

I claim:

1. A snap strip for securing a housing which contains a first aperture in an upper portion and a second aperture in a lower portion, the snap strip comprising:
an elongate strip having a first end and second end;
a first prong placed near the first end;
a second prong placed near the second end;
wherein the prongs are sized to allow initial insertion into the apertures but once inserted cannot be removed using the opposite motion as insertion.

2. The snap strip of claim 1 further comprising:
a tab attached at a top portion of the prong and extending towards a base portion of the prong.

3. The snap strip of claim 2 wherein:
the prong contains a central axis and the tab extends away from the central axis as you move from a top portion of the prong to a base portion of the prong.

4. The snap strip of claim 2 wherein:
a notch positioned near the base portion of each prong to accept a portion of each tab.

5. The snap strip of claim 1 further comprising:
a base portion of each prong which fits within the aperture in the housing once the prongs are fully inserted into the housings.

6. The snap strip of claim 1 wherein:
initial insertion of the prongs is permitted by tabs which flex inwardly but once inserted the tabs expand so that the prong cannot be removed using the opposite motion as insertion.

7. A device for preventing tampering with cable taps comprising:
an upper housing and a lower housing which are joined along an intersecting edge;
a pair of apertures in the upper housing which accept cable feeder lines;
a snap strip having an elongate strip with a first and second end, where a first prong is placed near the first end and a second prong is placed near the second end;
an upper aperture in the upper housing which is sized to accept the first prong; and
a lower aperture in the lower housing which is sized to accept the second prong.

8. The device of claim 7 further comprising:
an aperture in the upper housing which allows a hanger for the cable tap to pass through the upper housing.

9. The device of claim 7 further comprising:
an aperture in the bottom housing which allows a household cable line which is connected to the tap to pass through the bottom housing.

10. The device of claim 7 wherein:
a bottom portion of the aperture for the cable feed lines is defined by the lower housing, while
a top portion of the aperture for the cable feed lines is defined by the upper housing.

11. The device of claim 7 further comprising:
a tab attached at a top portion of the prong and extending towards a base portion of the prong.

12. The device of claim 11 wherein:
the prong contains a central axis and the tab extends away from the central axis as you move from a top portion of the prong to a base portion of the prong.

13. The device of claim 11 wherein:
a notch positioned near the base portion of each prong to accept a portion of each tab while its being inserted into the apertures of the upper and lower housings.

14. The device of claim 7 further comprising:
a base portion of each prong which fits within the aperture in the upper and lower housing once the prongs are fully inserted.

15. The device of claim 7 wherein:
initial insertion of the prongs is permitted by tabs which flex inwardly towards the center of the prong but once inserted the tabs expand so that the prong cannot be removed using the opposite motion as insertion.

16. A device for preventing tampering with cable taps comprising:
an upper housing and a lower housing which are joined along an intersecting edge;
a pair of apertures in the upper housing which accept cable feeder lines where each aperture contains a bottom portion defined by the bottom housing and an upper portion defined by the upper housing such that when joined the two housings sandwich the cable feeder lines;
a pair of snap strips each one having an elongate strip with a first and second end, where a first prong is placed near the first end and a second prong is placed near the second end;
a pair of upper apertures in the upper housing which are placed on opposite sides of the housing and sized to accept the first prong of a snap strip; and
a pair of lower apertures in the lower housing which are placed on opposite sides of the housing and sized to accept the second prong of a snap strip.

17. The device of claim 16 further comprising:
an aperture in the upper housing which allows a hanger for the cable tap to pass through the upper housing.

18. The device of claim 16 further comprising:
an aperture in the bottom housing which allows a household cable line which is connected to the tap to pass through the bottom housing.

19. The device of claim 16 further comprising:
a tab attached at a top portion of the prong and extending towards a base portion of the prong.

20. The device of claim 19 wherein:
a notch positioned near the base portion of each prong to accept a portion of each tab while its being inserted into the apertures of the upper and lower housings.
